(19) United States
(12) Patent Application Publication
(10) Pub. No.: US 2015/0220275 A1
(43) Pub. Date: Aug. 6, 2015

(54) METHOD FOR OPERATING NONVOLATILE STORAGE DEVICE AND METHOD FOR OPERATING COMPUTING DEVICE ACCESSING NONVOLATILE STORAGE DEVICE

(71) Applicant: SAMSUNG ELECTRONICS CO., LTD., SUWON-SI (KR)

(72) Inventors: SANG-JIN OH, SUWON-SI (KR); JONG TAE PARK, SEOUL (KR); SEUNGYEUN JEONG, ANSEONG-SI (KR)

(21) Appl. No.: 14/598,429

(22) Filed: Jan. 16, 2015

(30) Foreign Application Priority Data
Feb. 6, 2014 (KR) 10-2014-0013736

(51) Int. Cl. G06F 3/06

(52) U.S. Cl. CPC G06F 3/0611; G06F 3/0679; G06F 3/0659; G06F 2206/1014

(57) ABSTRACT

A method for operating a nonvolatile memory device including a nonvolatile memory and a memory controller configured to control the nonvolatile memory. The method includes receiving a read request, determining whether the received read request is a merged request, splitting the received read request into at least two read requests and executing the at least two read requests if the received read request is the merged request, and executing the received read request if the received read request is not the merged request.

### CROSS-REFERENCE TO RELATED APPLICATIONS

A claim of priority under 35 USC §119 is made to Korean Patent Application No. 10-2014-0013736, filed on Feb. 6, 2014, the entirety of which is hereby incorporated by reference.

### BACKGROUND

The present inventive concept herein relates to semiconductor devices and, more particularly, to a method for operating a nonvolatile storage device and a method for operating a computing device that accesses the nonvolatile storage device.

A computing device such as a personal computer (PC) and a laptop computer may be configured to communicate with a nonvolatile storage device according to various interface standards. For example, a computing device may communicate with a nonvolatile storage device such as a solid state drive (SSD) based on one of various standards such as USB (Universal Serial Bus), PCI (Pheripheral Component Interconnect), PCI-e (PCI express), SATA (Serial AT Attachment), eSATA, NVMe (NonVolatile Memory express), SCSI (Small Computer System Interface) and SAS (Serial Attached SCSI).

When a computing device desires to access a nonvolatile storage device, the computing device transmits a request (e.g., read, write or erase request) to the nonvolatile storage device. However, it may take a predetermined time for a computing device to transmit a request to a nonvolatile storage device. Accordingly, there is a related need to develop techniques and technologies to improve operating performance of a computing device and a nonvolatile storage device by reducing the time required for the computing device to transmit a request to the nonvolatile storage device.

### SUMMARY OF THE INVENTION

Embodiments of the inventive concept provide a method for operating a nonvolatile memory device including a nonvolatile memory and a memory controller configured to control the nonvolatile memory. In some embodiments of the inventive concept, the method may include receiving a read request; determining whether the received read request is a merged request; splitting the received read request into at least two read requests and executing the at least two read requests if the received read request is the merged request; and executing the received read request if the received read request is not the merged request.

In some embodiments of the inventive concept, the read request may include a frame information structure (FIS) based on a serial ATA (SATA) standard.

In some embodiments of the inventive concept, the determining may be performed by checking flag information included in the read request.

In some embodiments of the inventive concept, the determining may be performed by checking a value of a last one of address bits included in the read request.

In some embodiments of the inventive concept, a determination operation may be performed to determine whether a value of an address included in the received read request is within a range of an address of the nonvolatile memory if the received read request is not the merged request. The determination operation may be omitted if the received read request is the merged request.

In some embodiments of the inventive concept, at least two addresses respectively corresponding to the at least two read requests may be extracted from an address field of the received read request if the received read request is the merged request.

In some embodiments of the inventive concept, at least two cluster counts respectively corresponding to the at least two read requests may be extracted from a feature field of the received read request if the received request is the merged request.

In some embodiments of the inventive concept, at least two cluster counts respectively corresponding to the at least two read requests may be extracted from a count field of the received read request if the received read request is the merged request.

In some embodiments of the inventive concept, an address included in the received read request may indicate one of clusters assigned to the nonvolatile memory, and each of the clusters may include two or more sectors.

Embodiments of the inventive concept also provide a method for operating a computing device configured to access a nonvolatile storage device. In some embodiments of the inventive concept, the method may include generating at least two read requests for the nonvolatile storage device; determining whether the at least two read requests correspond to a merge target; merging the at least two read requests into a single read request and transmitting the merged read request to the nonvolatile storage device if the at least two read requests correspond to the merge target; and transmitting the at least two read requests to the nonvolatile storage device if the at least two read requests do not correspond to the merge target.

In some embodiments of the inventive concept, the determining may be performed according to a total size of data requested by the at least two read requests.

In some embodiments of the inventive concept, the determining may include determining that the at least two read requests correspond to the merge target if a total size of data requested by the at least two read requests is equal to or smaller than a maximum transmission unit indicating a maximum size of data that the computing device communicates with the nonvolatile storage device at one time; and determining that the at least two read requests do not correspond to the merge target if the total size of data requested by the at least two read requests is greater than the maximum transmission unit.

In some embodiments of the inventive concept, the single read request may include a frame information structure (FIS) based on a serial ATA (SATA) standard.

In some embodiments of the inventive concept, the computing device may support a native command queuing (NCQ).

In some embodiments of the inventive concept, an address included in the single read request may indicate a single cluster assigned to the nonvolatile storage device, and each cluster assigned to the nonvolatile storage device may include two or more clusters.

Embodiments of the inventive concept also provide a storage device. In some embodiments of the inventive concept, the storage device may include a nonvolatile memory; and a memory controller configured to control the nonvolatile memory. The memory controller may include a memory interface configured to read data from the nonvolatile memory; and a host interface configured to receive a read request from an external device. When the received read request is a merged read request, the host interface may be configured to split the received read request into at least two read requests and transfer the split at least two read requests to the memory interface. When the received read request is not the merged read request, the host interface may be configured to transfer the received read request to the memory interface.

In some embodiments of the inventive concept, the host interface may be configured to output data to the external device at least twice according to the received read request when the read request is the merged read request.

In some embodiments of the inventive concept, the host interface may be configured to check an address of the received read request to determine whether the address is valid or not when the received read request is not the merged read request. The host interface may be configured not to check the address to determine whether the address is valid when the received read request is the merged read request.

In some embodiments of the inventive concept, the host interface may be configured to determine whether the received read request is the merged request or not according to a first flag bit of the received read request and determine whether the received read request supports a merge mode, which allows the merged read request, according to a second flag bit of the received read request.

In some embodiments of the inventive concept, the nonvolatile memory may include a plurality of cell strings arranged in rows and columns on a substrate, each cell sting including at least one ground select transistor, a plurality of memory cells and at least one string select transistor, which are sequentially stacked on the substrate in a direction perpendicular to the substrate.

### BRIEF DESCRIPTION OF THE DRAWINGS

The accompanying drawings are included to provide a further understanding of the inventive concepts, and are incorporated in and constitute a part of this specification. The drawings illustrate exemplary embodiments of the inventive concepts and, together with the description, serve to explain principles of the inventive concepts.

FIG. 1 is a block diagram of a computing system according to an embodiment of the inventive concept.

FIG. 2 is a block diagram of a computing device according to an embodiment of the inventive concept.

FIG. 3 is a block diagram of a software layer according to an embodiment of the inventive concept, which is driven in a computing device.

FIG. 4 is a flowchart summarizing a method for operating a computing device according to an embodiment of the inventive concept.

FIG. 5 is a flowchart summarizing an example of determining whether a read request is a merge target.

FIG. 6 illustrates an example of a request transmitted to a storage device by a computing device.

FIGS. 7 and 8 illustrate an example of a merged request of two read requests according to an embodiment of the inventive concept.

FIGS. 9 and 10 illustrate another example of a merged request of two read requests according to an embodiment of the inventive concept.

FIG. 11 illustrates another example of a merged request of two read requests according to an embodiment of the inventive concept.

FIG. 12 is a flowchart summarizing another example of a method for operating a computing device according to an embodiment of the inventive concept.

FIG. 13 is a block diagram of a software layer according to another embodiment of the inventive concept.

FIG. 14 is a block diagram of a storage device according to an embodiment of the inventive concept.

FIG. 15 is a flowchart summarizing a method for operating a storage device according to an embodiment of the inventive concept.

FIG. 16 is a block diagram of a storage device according to another embodiment of the inventive concept.

FIG. 17 is a flowchart summarizing a method for operating a computing system according to another embodiment of the inventive concept.

FIG. 18 is a block diagram of a nonvolatile memory according to an embodiment of the inventive concept.

FIG. 19 is a circuit diagram of a memory block according to an embodiment of the inventive concept.

FIG. 20 is a circuit diagram of a memory block according to another embodiment of the inventive concept.

FIG. 21 is a block diagram of a storage device according to another embodiment of the inventive concept.

FIG. 22 is a block diagram of a storage module according to an embodiment of the inventive concept.

### DETAILED DESCRIPTION

Exemplary embodiments in accordance with the inventive concept will now be described more fully hereinafter with reference to the accompanying drawings.

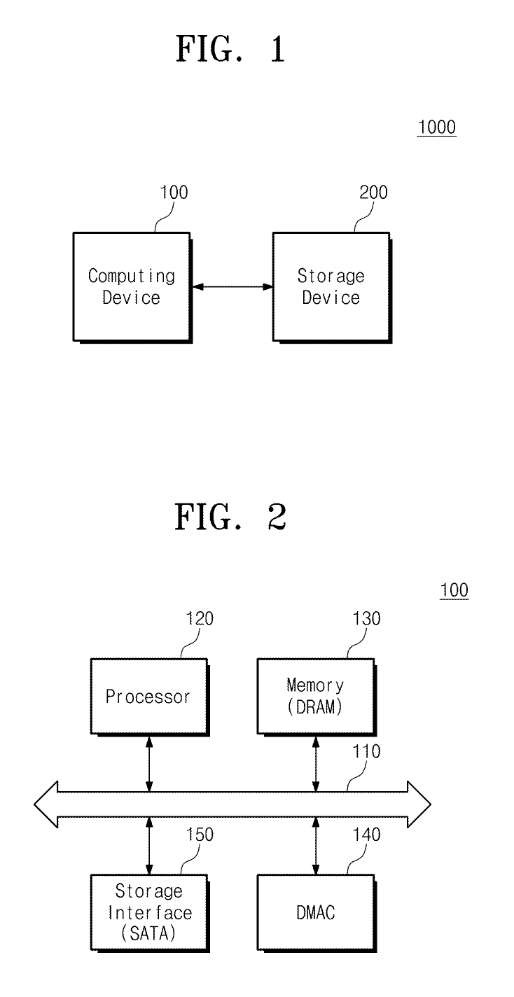

FIG. 1 is a block diagram of a computing system 1000 according to an embodiment of the inventive concept. As illustrated, the computing system 1000 includes a computing device 100 and a storage device 200.

The computing device 100 may access the storage device 200. The computing device 100 may write data into the storage device 200, read the data written into the storage device 200 or erase the data written into the storage device 200. The computing device 100 may include a general-purpose computer such as a personal computer (PC) and a laptop computer. The computing device 100 may include a mobile device such as a smartphone and a smart pad.

The storage device 200 may perform a read operation, a write operation or an erase operation according to the control of the computing device 100. The storage device 200 may include any nonvolatile storage medium such as a solid-state drive (SSD), a hard disk drive (HDD), and an optical disk drive (ODD).

FIG. 2 is a block diagram of a computing device 100 according to an embodiment of the inventive concept. Referring to FIGS. 1 and 2, the computing device 100 includes a bus 110, a processor 120, a memory 130, a DMA controller 140, and a storage interface 150.

The bus 110 is configured to provide a channel between components of the computing device 100. The bus 110 may include a peripheral component interconnect (PCI) bus, a PCI-e bus, and an AMBA bus.

The processor 120 is configured to control the overall operation of the computing device 100. The processor 120 may perform a logical operation. For example, the processor 120 may include a system-on-chip (SoC). The processor 120 may be a general-purpose processor, a graphic processor or an application processor.

The memory 130 may communicate with the processor 120. The memory 130 may be a main memory of the processor 120 or the computing device 100. The processor 120 may temporarily store a code or data in the memory 130. The processor 120 may execute a code and process data using the memory 130. The processor 120 may execute various types of software such as an operating system (OS) and an application. The processor 120 may control the overall operation of the computing device 100 using the memory 130. The memory 130 may include a volatile memory such as a static RAM (SRAM), a dynamic RAM (DRAM), and a synchronous DRAM (SDRAM) or a nonvolatile memory such as a phase-change RAM (PRAM), a magnetic RAM (MRAM), a resistive RAM (RRAM), and a ferroelectric RAM (FRAM). The memory 130 may include a random access memory (RAM). In the embodiment of FIG. 2, memory 130 is a DRAM, but it is not limited thereto and may be any other type of memory.

The DMA controller 140 may operate according to a request from the processor 120 or other components of the computing device 100. The DMA controller 140 may operate with a request of the storage device 200. The DMA controller 140 may transmit or receive data, based on a received request.

The storage interface 150 may communicate with the storage 200 according to a request of the processor 120 or the DMA controller 140. The storage interface 150 may communicate with the storage device 200, based on at least one of various standards such as serial AT attachment (SATA), PCI, PCIe, universal serial bus (USB), SCSI, SAS, and nonvolatile memory express (NVMe). In the embodiment of FIG. 2, the storage interface 150 communicates with the storage device 200 based on the SATA standard, but it is not limited thereto and may communicate based on any other standard.

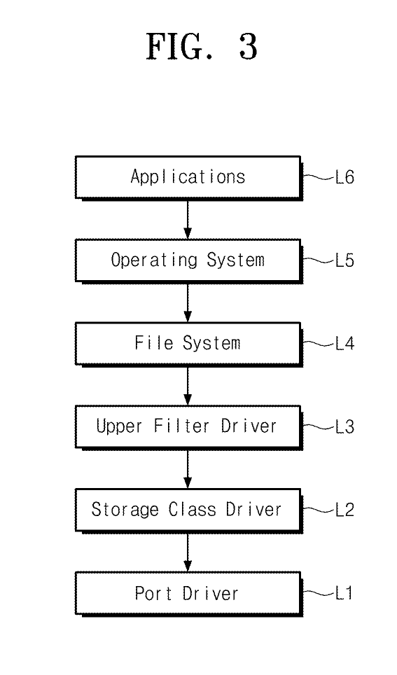

FIG. 3 is a block diagram of a software layer according to an embodiment of the inventive concept, which is driven in the computing device 100. Referring to FIGS. 1 to 3, applications L6 may be disposed at an uppermost level. The applications L6 may include a word processor, a spreadsheet, a database, a file manager, an internet explorer, a game, and the like.

An operating system L5 may be disposed at a lower level than the applications L6. The operating system L5 may control the overall operation of the computing system 1000. The operating system L5 may provide a platform where the applications L6 are driven.

A file system L4 may be disposed at a lower level than the operating system L5. The file system L4 may manage data written into a storage space of the storage device 200 and the storage device 200. The file system L4 may access and manage the storage device 200 according to a request of the operating system L5 or the applications L6.

An upper filter driver L3 is disposed at a lower level of the file system L4. The upper file system L3 may receive a request for accessing the storage device 200 from the file system L4 and merge requests that meet a predetermined condition among the received requests.

A storage class driver L2 is disposed at a lower level than the upper filter driver L3. The storage class driver L2 may convert an access request generated by the applications L6 or the operating system L2. For example, the storage class driver L2 may receive an I/O request pocket (IRP) and convert the received IRP to SCSI request blocks (SRB).

A port driver L1 is disposed at a lower level than the storage class driver L2. The port driver L1 may convert the access request received from the storage class driver L2. For example, the port driver L1 may convert the received access request to be suitable for type of an interface to connect the computing device 100 and the storage device 200. The request converted by the port driver L1 is transferred to the storage device 200.

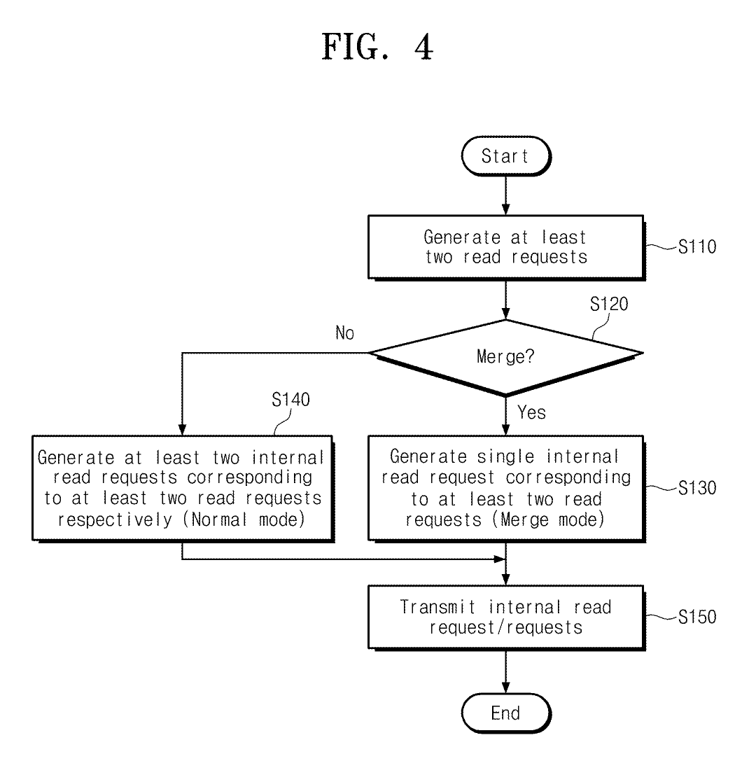

FIG. 4 is a flowchart summarizing a method for operating the computing device 100 according to an embodiment of the inventive concept. Referring to FIGS. 1 to 4, at least two read requests are generated (S110). For example, the applications L6 or the operating system L2 driven in the computing device 100 may generate at least two read requests. For example, at least two read requests may be generated according to remote control from a remote device, a request of a user who uses the computing device 100 or a predetermined schedule.

Determination is made as to whether the at least two read requests are a merge target (S120). For example, the upper filter driver L3 may determine whether the least two read requests are a merge target.

If the at least two read requests are the merge target, a merge mode is performed (S130). In the merge mode, a single internal read request corresponding to the at least two read requests may be generated. The upper filter driver L3 may control the storage class driver L2 or the port driver L1 to generate the single internal read request corresponding to the at least two read requests.

If the at least two read requests are not the merge target, a normal mode is performed (S140). In the normal mode, two internal read requests respectively corresponding to the at least two read requests are generated. The upper filter driver L3 may control the storage class driver L2 or the port driver L1 to generate at least two internal read requests in the normal mode.

The internal read request is transmitted (S150). When a single internal read request is generated in the merge mode, the single internal read request may be transmitted to the storage device 200. When at least two internal read requests are generated in the normal mode, the at least two internal read requests may be transmitted to the storage device 200.

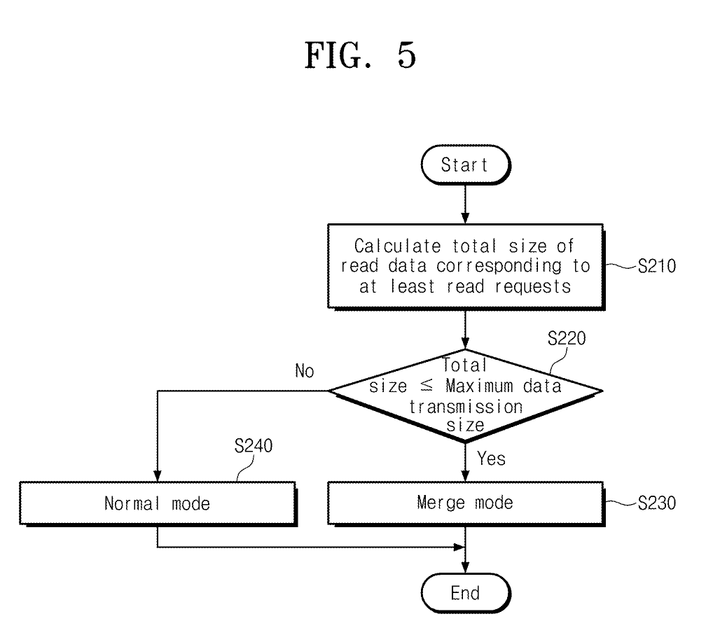

FIG. 5 is a flowchart summarizing an example of determining whether a read request is a merge target. Referring to FIGS. 1 to 5, the total size of read data corresponding to at least two requests is calculated (S210). For example, the total size of data requested by the respective at least two read requests may be calculated.

Determination is made as to whether the calculated total size is equal to or smaller than maximum data transmission size (S220). The maximum data transmission size may be the maximum size of data requested at one time to the storage device 200 or received at one time from the storage device 200. For example, the maximum data transmission size may be 128 kilobytes (KB) or 1 megabyte (MB). The maximum data transmission size may be defined by types of the processor 120 or the operating system L5.

If the total size is equal to or smaller than the maximum data transmission size, the at least two read requests is determined as the merge target. That is, the merge mode is decided (S230). If the total size is greater than the maximum data transmission size, the at least two read requests is determined as not the merge target. That is, the normal mode is decided (S240).

In some embodiments, when a size of read-requested data is greater than the maximum data transmission size, the processor 120 or the DMA controller 140 is configured to generate a plurality of internal read requests. Each of the internal read requests may request a less amount of data than the maximum data transmission size. If a size of needed data is more than the maximum data transmission size, the processor 120 or the DMA controller 140 may transmit a plurality of read requests of the needed data in a unit of the maximum transmission size to the storage device 200. That is, when a size of data requested by a merged internal read request is greater than the maximum data transmission size, the merged internal read request is re-split by the processor 120 or the DMA controller 140. In order to prevent this problem, the merge according to an embodiment of the inventive concept may be set to be carried out only when the total size of the read-requested data is equal to or smaller than the maximum data transmission size.

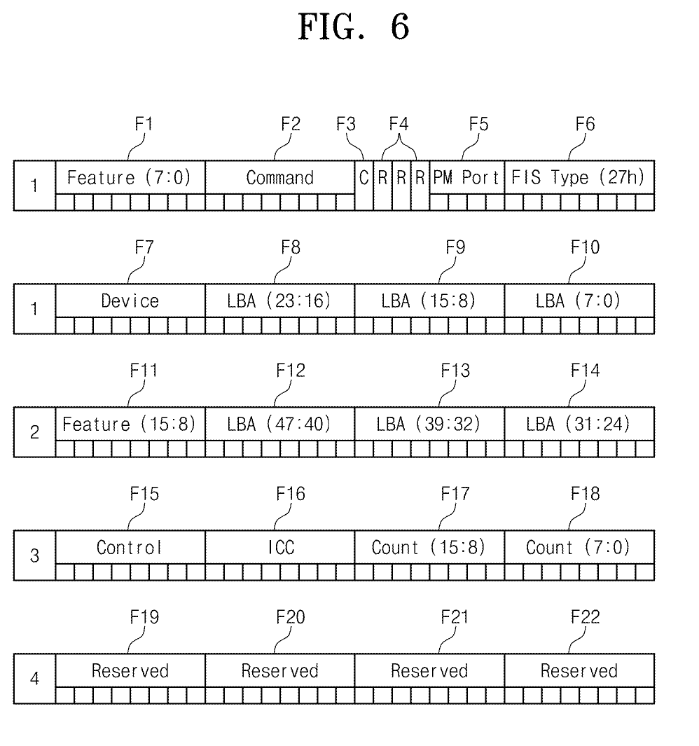

FIG. 6 illustrates an example of a request transmitted to the storage device 200 by the computing device 100. A SATA-based frame information structure (FIS) is exemplarily shown in FIG. 6.

Referring to FIG. 6, the FIS includes first to eighteenth fields F1 to F18. The first field F1 includes zeroth to seventh bits. If the computing device 100 supports native command queuing (NCQ), the first field may include information on a sector count in the normal mode. If the computing device 100 does not support the NCQ, the first field F1 may not include information in the normal mode.

The second field F2 includes contents of a command register in a shadow register block. The second field F2 may be set as defined in the specification of the SATA standard.

The third field F3 includes information indicating whether register transmission arises from update of a command register or update of a device control register. The third field F3 may be set as defined in the specification of the SATA standard.

The fourth field F4 includes reserved bits. The fourth field F4 may be set as defined in the specification of the SATA standard.

The fifth field F5 includes information on a port address. For example, when the storage device 200 is connected to the computing device 100 via a port multiplier, ports may be distinguished through the fifth field F5. The fifth field F5 may be set as defined in the specification of the SATA standard.

The sixth field F6 includes information on FIS type. For example, in case of FIS transmitted from the computing device 100 to the storage device 200, the sixth field F6 may be set to ‘27h’. The sixth field F4 may be set as defined in the specification of the SATA standard.

The seventh field F7 may include contents of the device register in the shadow register bock. The seventh field F7 may be set as defined in the specification of the SATA standard.

The eighth field F8 includes sixteenth to twenty third logical address bits. The ninth field F9 includes eighth to fifteenth logical address bits. The tenth field F10 includes zeroth to seventh logical address bits.

The eleventh field F11 includes eighth to fifteenth feature bits. In the normal mode, the eleventh field F11 may not include information.

The twelfth field F12 may include fortieth to forty seventh logical address bits. The thirteenth field F13 may include thirty second to thirty ninth logical address bits. The fourteenth field F14 may include twenty fourth to thirty first logical address bits.

The eighth to tenth fields F8 to F10 and the twelfth to fourteenth fields F12 to F14 include zeroth to forty seventh logical bit addresses. In the normal mode, the eighth to tenth fields F8 to F10 and the twelfth to fourteenth fields F12 to F14 may include a logical address indicating a single sector or a single cluster. Cluster may be an access unit defined by the operating system L5. The cluster may include two or more sectors.

The fifteenth field F15 may include contents of the device register in the shadow register block. The fifteenth field F15 may be set as defined in the specification of the SATA standard.

The sixteenth field F16 may include information on limited time. The sixteenth field F16 may be set as defined in the specification of the SATA standard.

The seventeenth field F17 may include eighth to fifteenth count bits. In the normal mode, the seventeenth field F17 may not include information.

The eighteenth field F18 includes zeroth to seventh count bits. If the computing device 100 supports the NCQ, the eighth field F18 may not include information in the normal mode. If the computing device 100 does not support the NCQ, the eighth field F18 may include a sector count or a cluster count. The sector count may indicate how many sectors are access targets from a sector pointed out by the eighth to tenth fields F8 to F10 and the twelfth to fourteenth fields F12 to F14. The cluster count may indicate how many clusters are access targets from a cluster pointed out by the eighth to tenth fields F8 to F10 and the twelfth to fourteenth fields F12 to F14.

The FIS may further include ninth to twenty second fields F19 to F22. The ninth to twenty second fields F19 to F22 may be reserved fields. The ninth to twenty second fields F19 to F22 may be set as defined in the specification of the SATA standard.

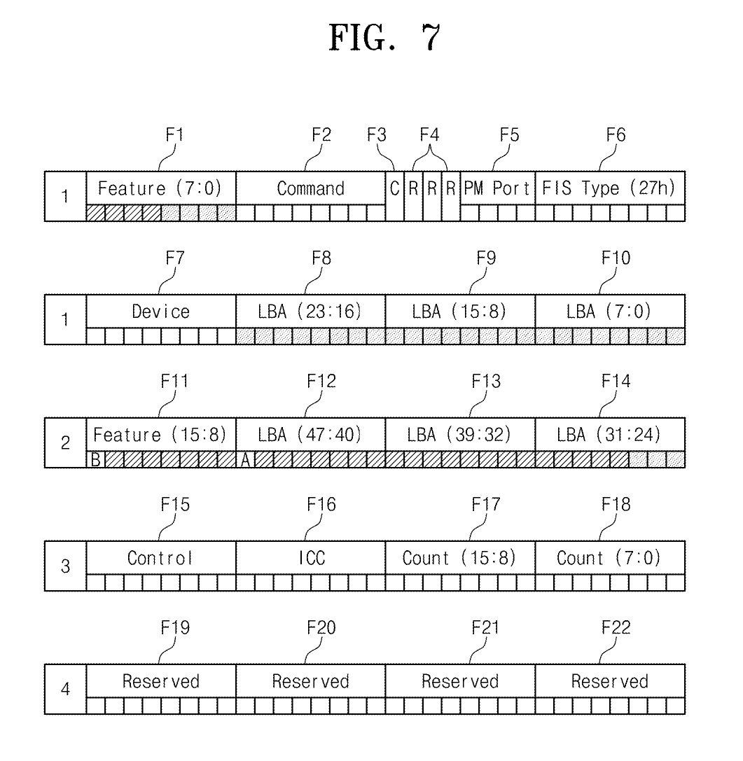

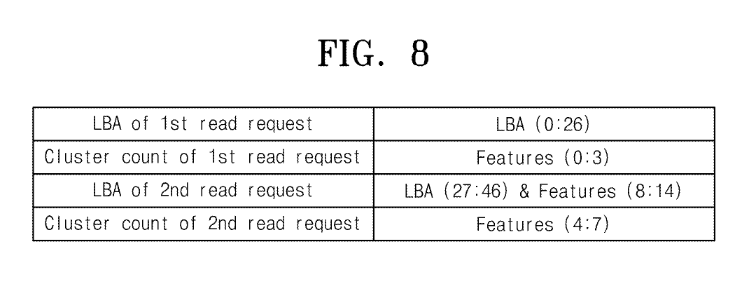

FIGS. 7 and 8 illustrate an example of a merged request of two read requests according to an embodiment of the inventive concept. An example of a FIS transmitted from the computing device 100 to the storage device 200 is shown in FIGS. 7 and 8 where the computing device 100 supports the NCQ. As shown in FIG. 7, bits corresponding to a first read request are filled with dots and bits corresponding to a second read request are filled with diagonal lines.

Referring to FIGS. 7 and 8, eighth to tenth fields F8 to F10 and a portion of the fourteenth field F14 include a logical address associated with the first read request. The logical address associated with the first read request may indicate a single cluster of the storage device 200. The logical address associated with the first read request is expressed by 27 bits.

A portion of an eleventh field F11, a portion of a fourteenth field F14, a thirteenth field F13 include a logical address associated with a second read request. The logical address associated with the second read request may include a single cluster of the storage device 200. The logical address associated with the second read request is expressed by 27 bits.

A first field F1 includes a cluster count associated with the first read request and a cluster count associated with the second read request.

A twelfth field F12 includes a first flag A. The first flag A may indicate whether the FIS transmitted from the computing device 100 to the storage device 200 is a merged form or a normal form.

The eleventh field F11 includes a second flag B. The second flag B may include information on whether the computing device 100 or the storage device 200 supports a merge mode according to an embodiment of the inventive concept.

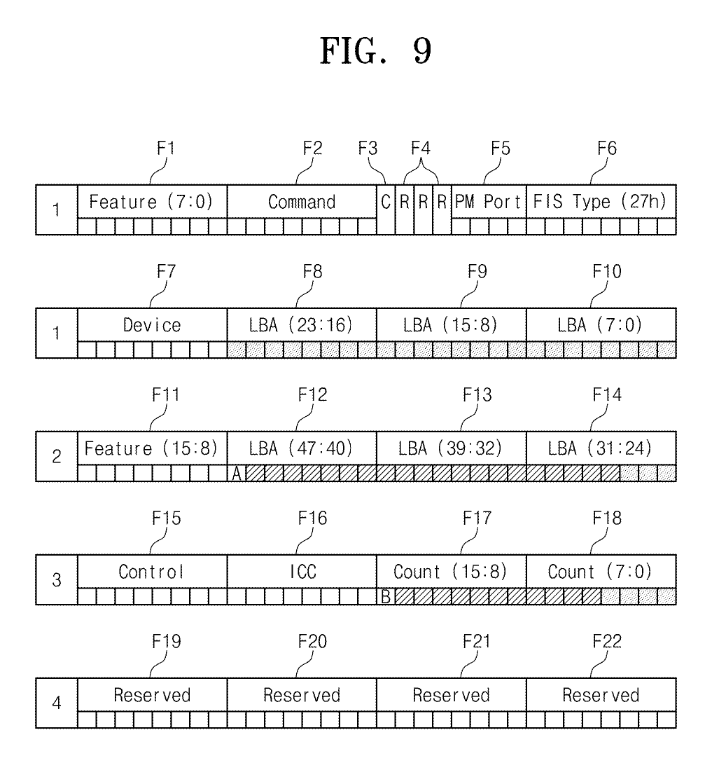

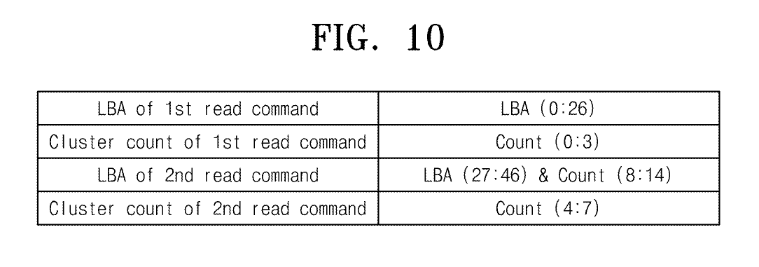

FIGS. 9 and 10 illustrate another example of a merged request of two read requests according to an embodiment of the inventive concept. An example of FIS transmitted from the computing device 100 to the storage device 200 is shown in FIGS. 9 and 10 where the computing device does not support the NCQ. As shown in FIG. 9, bits corresponding to a first read request are filled with dots and bits corresponding to a second read request are filled with diagonal lines.

Referring to FIGS. 9 and 10, eighth to tenth fields F8 to F10 and a portion of a fourteenth field F14 include a logical address associated with a first read request. The logical address associated with the first read request may include a single cluster of the storage device 200. The logical address associated with the first read request is expressed by 27 bits.

A portion of a twelfth field F12, the portion of the fourteenth field F14, a portion of a seventeenth field F17, and a thirteenth field F13 include a logical address associated with a second read request. The logical address associated with the second read request may include a single cluster of the storage device 200. The logical address associated with the second read request is expressed by 27 bits.

An eighteenth field F18 includes a cluster count associated with the first read request and a cluster count associated with the second read request.

A twelfth field F12 includes a first flag A. The first flag A may indicate whether the FIS transmitted from the computing device 100 to the storage device 200 is a merged form or a normal form.

A seventeenth field F17 includes a second flag B. The second flag may include information on whether the computing device 100 or the storage device 200 supports a merge mode according to an embodiment of the inventive concept.

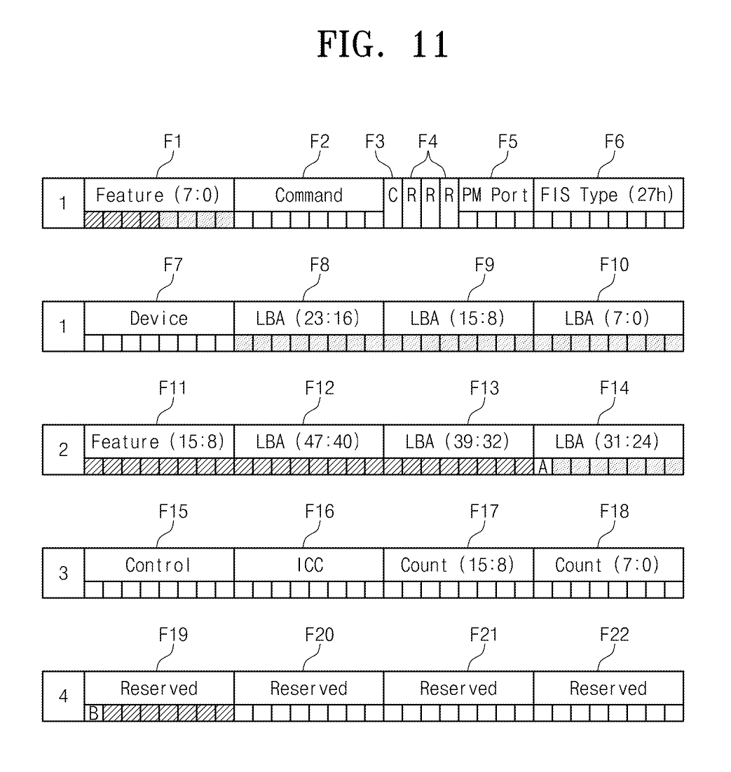

FIG. 11 illustrates another example of a merged request of two read requests according to an embodiment of the inventive concept. Referring to FIG. 11, a logical address of a second read request may be expressed using a nineteenth field F19 that is a reserved field.

That is, as described with reference to FIGS. 7 to 10, logical addresses of two or more read requests may be set to fields designated to include a logical address. The number of logical address bits assigned to a single read request in a merge mode is smaller than that in a normal mode. If the number of logical address bits decreases, capacity of the storage device 200 that the computing device 100 can access may decrease. This problem may be overcome by setting a target indicated by a logical address to be not a sector but a cluster of the storage device 200. If the target indicated by the logical address is changed to a cluster from a sector, the capacity of the storage device 200 that the computing device 100 can access increases. In addition, an operating system L5 or applications L6 generally generates a read request in units of not sectors but clusters. Thus, although the target indicated by the logical address is changed to a cluster, the storage device 200 is normally accessed without causing any changes in the operating system L5 or the applications L6.

As described with reference to FIG. 11, in a merge mode, logical addresses may be set to fields defined as reserved fields in an existing SATA standard. In this case, there is no problem of decreasing the capacity of the storage device 200 that the computing device 100 can access. That is, the capacity of the storage device 100 is accessed in a unit of a cluster not a sector by using at least one of nineteenth to twelve second fields F19 to F22 which are the reserved fields of the existing SATA standard.

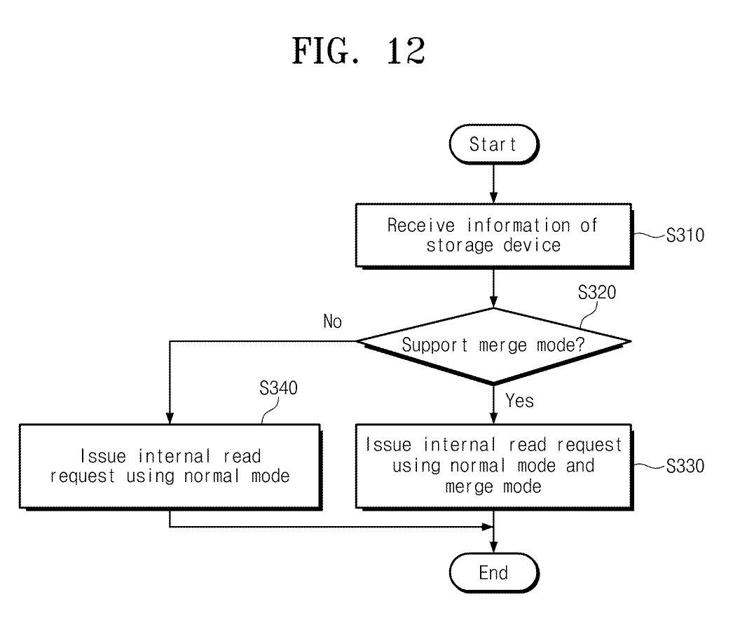

FIG. 12 is a flowchart summarizing another example of a method for operating the computing device 100 according to an embodiment of the inventive concept. Referring to FIGS. 1 and 12, information of the storage device 200 is received (S310). For example, when the storage 200 is connected to the computing device 100 or the storage device 200 and the computing device 100 is supplied with power, the computing device 100 may receive information from the storage device 200.

The computing device 100 determines whether the storage device 200 supports a merge mode (S320). The computing device 100 may determine whether the storage device 200 supports the merge mode, based on the information received from the storage device 200.

If the storage device 200 supports the merge mode, the computing device 100 may issue an internal read request to the storage device 200 using a normal mode and the merge mode (S330).

If the storage device 200 does not support the merge mode, the computing device 100 may issue the internal read request to the storage device 200 using only the normal mode (S340).

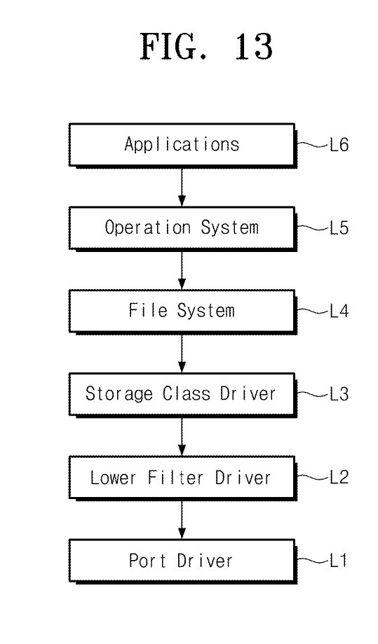

FIG. 13 is a block diagram of a software layer according to another embodiment of the inventive concept. As illustrated, an operating system L5 is provided at a lower level than applications L6, a file system L4 is provided at a lower level than the operating system L5, a storage class driver L3 is provided at a lower level than the file system L4, a lower filter driver L2 is provided at a lower level than the storage class driver L3, and a port driver L1 is provided at a lower level than the lower filter driver L2.

The lower filter driver L2 may determine whether at least two read request are a merge target and decide the merge mode or a normal mode according to a result of the determination. The port driver L1 may generate an internal read request in the merge mode or the normal mode according to the control of the lower filter driver L2. As compared to the software layer in FIG. 3, the filter driver L2 supporting a merge function is provided between the storage class driver L3 and the port driver L1.

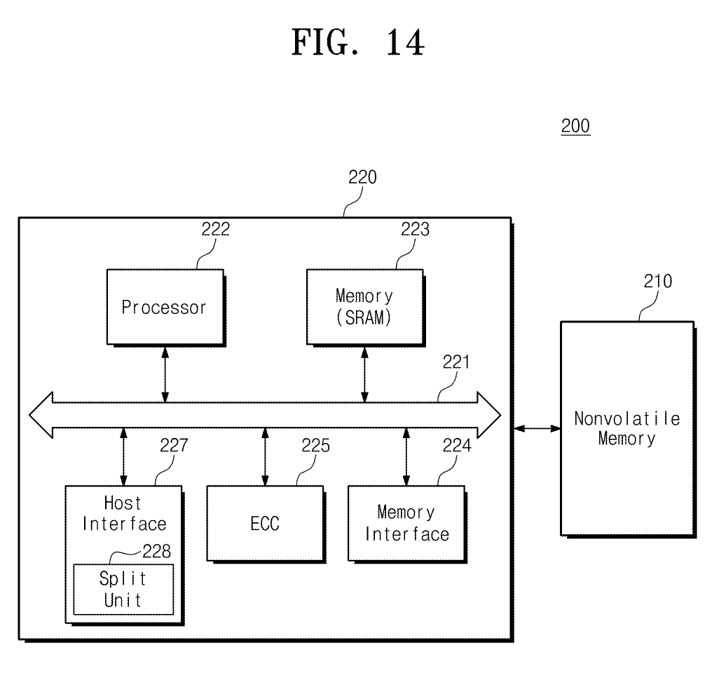

FIG. 14 is a block diagram of a storage device 200 according to an embodiment of the inventive concept. Referring to FIGS. 1 and 14, the storage device 200 includes a nonvolatile memory 210 and a memory controller 220.

The nonvolatile memory 210 may perform a write operation, a read operation, and an erase operation according to the control of the memory controller 220. The nonvolatile memory 210 may include a flash memory, a phase-change RAM (PRAM), a magnetic RAM (MRAM), a ferroelectric RAM (FeRAM), a resistive RAM (RRAM), and the like.

The memory controller 220 may access the nonvolatile memory 210 according to a request of the computing device 100. The memory controller 220 may access the nonvolatile memory 210 according to a predetermined schedule. The memory controller 220 includes an internal bus 221, a processor 222, a memory 223, a memory interface 224, an error correction block (ECC) 225, and a host interface 227.

The internal bus 221 is configured to provide a channel between components of the memory controller 220.

The processor 222 may control the overall operation of the memory controller 220 and perform a logical operation. The processor 222 may communicate with the computing device 100 through the host interface 227. The processor 222 may communicate with the nonvolatile memory 210 through the memory interface 224. The processor 222 may include a microcontroller.

The memory 223 may be used as a working memory, a cache memory or a buffer memory of the processor 222. The memory 223 may store codes and commands executed by the processor 222. The memory 223 may store data processed by the processor 222. The memory 223 may include an SRAM.

The memory interface 224 may communicate with the nonvolatile memory 210 according to the control of the processor 222.

The ECC 225 may perform error correction. The ECC 225 may generate a parity to perform error correction, based on data to be written into the nonvolatile memory 210. The data and the parity may be transmitted to the nonvolatile memory 210 through the memory interface 224 and may be written into the nonvolatile memory 210. The ECC 225 may correct an error of data using the data and the parity read from the nonvolatile memory 210 through the memory interface 224.

The host interface 227 may communicate with the computing device 100 according to the control of the processor 222. The host interface 227 includes a split unit 228.

The split unit 228 determines whether an internal read request received from the computing device 100 is a merged request. If the received internal read request is the merged request, the split unit 228 may split the received internal read request into two internal read requests.

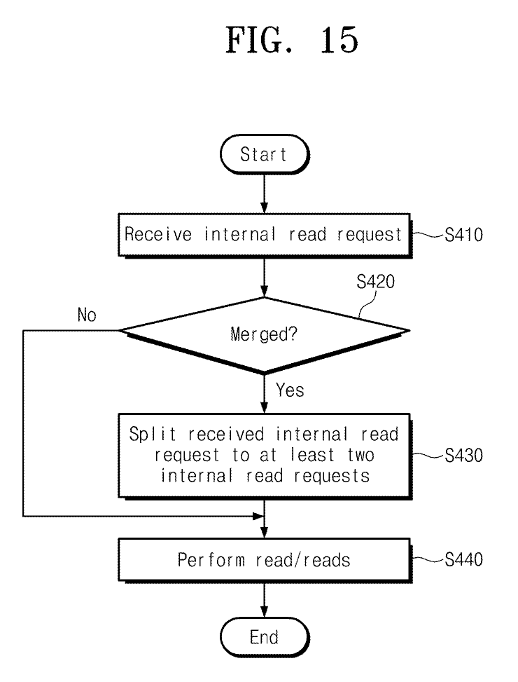

FIG. 15 is a flowchart summarizing a method for operating the storage device 200 according to an embodiment of the inventive concept. Referring to FIGS. 1, 14, and 15, an internal read request is received (S410).

Determination is made as to whether the received internal read request is a merged read request (S420). For example, as described with reference to FIGS. 7 to 11, the split unit 228 may check a first flag A of a FIS to determine whether the received internal read request is a merged read request.

If the received internal read request is a merged read request, the received internal read request is split into at least two internal read requests (S430).

A read operation is performed (S440). For example, when the internal read request is split, the read operation may be performed two or more times. When the internal read request is not split, the read operation may be performed once.

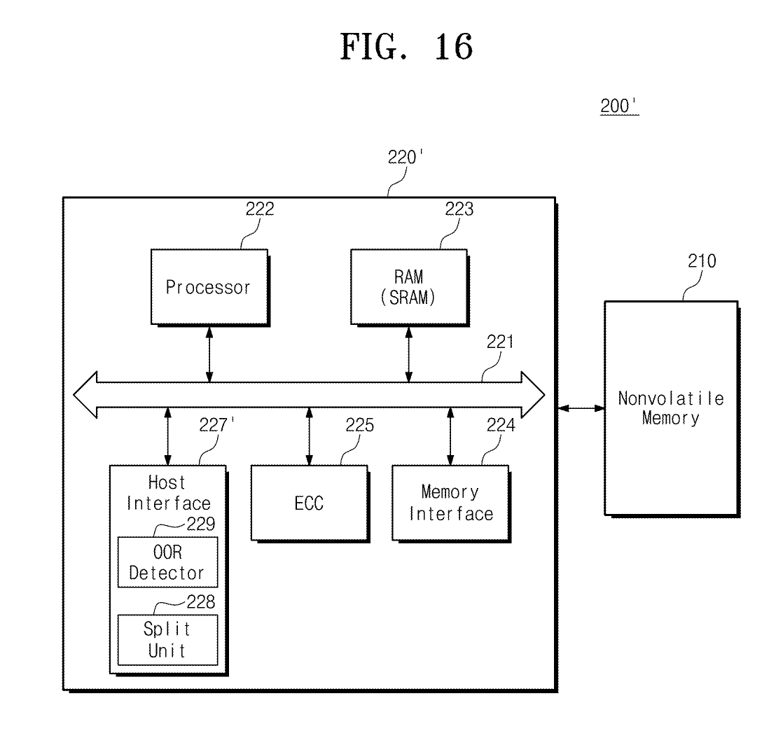

FIG. 16 is a block diagram of a storage device 200′ according to another embodiment of the inventive concept. As illustrated, the storage device 200′ includes a nonvolatile memory 210 and a memory controller 220′. The memory controller 220′ includes an internal bus 221, a processor 222, a RAM 223, a memory interface 224, an error correction block (ECC) 225, and a host interface 227′. Apart from the host interface 227′ that is provided with an out-of-range (OOR) detector 229, the storage device 200′ is identical to the storage device 200 shown in FIG. 14. Therefore, duplicate components will not be explained in further detail.

The host interface 227′ includes the split unit 228 and the OOR detector 229. The OOR detector 229 may detect whether a logical address received from the computing device 100 is out of the range of the storage device 200′. For example, when a logical address included in a FIS received from the computing device 100 is out of the range of a logical address allocated to the storage device 200′, the OOR detector 229 may notify the computing device 100 that an error occurs.

As described with reference to FIGS. 7 to 11, a logical address is expressed as 48 bits. That is, the computing device 100 may access the storage device 200′ having maximum capacity of 2̂48 sectors, i.e., 131072 TB. Conventionally, a storage device having the above capacity is not used. Thus, conventionally, when the last bit of a logical address has a valid value, the OOR detector 229 may determine that an out-of-range address is received and process the out-out-range address as an error. The OOR detector 229 may be configured using hardware.

When a merge mode is used according to an embodiment of the inventive concept, a first flag A is used as the last bit of a logical address. Thus, when a request merged according to the merge mode is received, the split unit 228 may control the OOR detector 229 so as not to perform out-of-range detection.

The OOR detector 229 may be configured not to perform out-of-range detection on the last bit of a logical address used as the first flag A. The OOR detector 229 may be configured to perform the out-of-range detection when the last bit has an invalid value. The OOR detector 229 may be configured not to perform the out-of-range detection when the last bit has a valid value.

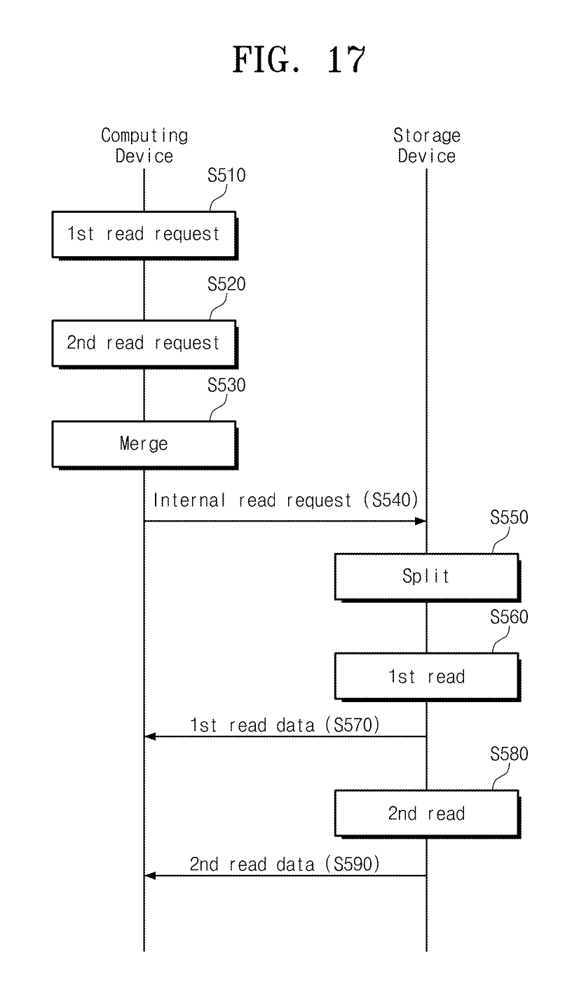

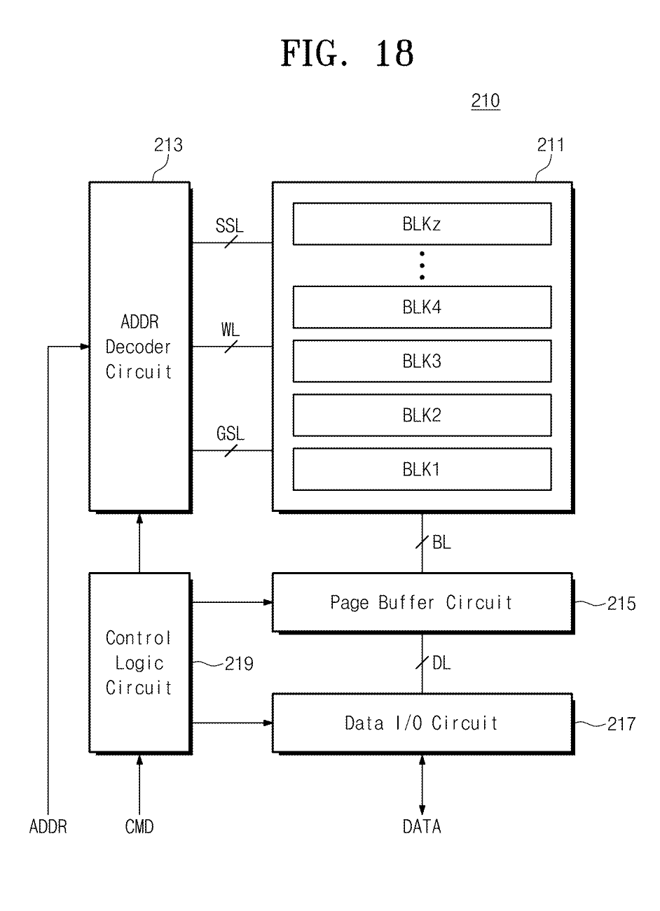

FIG. 17 is a flowchart summarizing a method for operating a computing system 1000 according to another embodiment of the inventive concept. Referring to FIGS. 1, 3, and 17, the computing device 100 may generate a first read request (S510). The computing device 100 may generate a second read request (S520).

The computing device 100 may merge the first and second read requests (S530). The computing device 100 may transmit a merged internal read request to the storage device 200 (S540).

The storage device 200 may split the received internal read request into first and second internal read requests (S550). The first and second internal read requests may correspond to the first and second read requests, respectively.

The storage device 200 may perform a first read operation according to the spit first internal read request (S560). The storage device 200 may transmit first read data depending on the first read operation to the computing device 100 (S570).

The storage device 200 may perform a second read operation according to the split second internal read request (S580). The storage device 200 may transmit second read data depending on the second read operation to the computing device 100 (S590).

FIG. 18 is a block diagram of a nonvolatile memory 210 according to an embodiment of the inventive concept. As illustrated, the nonvolatile memory 210 includes a memory cell array 211, an address decoder circuit 213, a page buffer circuit 215, a data input/output (I/O) circuit 217, and a control logic circuit 219.

The memory cell array 211 includes a plurality of memory blocks BLK1 to BLKz. Each of the memory blocks BLK1 to BLKz includes a plurality of memory cells. Each of the memory blocks BLK1 to BLKz may be connected to the address decoder circuit 213 through at least one string selection line GSL, a plurality of wordlines WL, and at least one string selection line SSL. Each of the memory blocks BLK1 to BLKz may be connected to the page buffer circuit 215 through a plurality of bitlines BL. The memory blocks BLK1 to BLKz may be commonly connected to the bitlines BL. The memory cells of the memory blocks BLK1 to BLKz may have the same structure.

The address decoder circuit 213 is connected to the memory cell array 211 through a plurality of ground selection lines GSL, a plurality of wordlines WL, and a plurality of string selection lines SSL. The address decoder circuit 213 operates according to the control of the control logic circuit 219. The address decoder circuit 213 may receive an address from the memory controller 220 (see FIG. 3). The address decoder circuit 213 may decode a received address ADDR and control voltages applied to wordlines WL according to the decoded address. For example, during a program operation, the address decoder circuit 213 may apply a pass voltage to the wordlines WL according to the control of the control logic circuit 219. During the program operation, the address decoder circuit 213 may further apply a program voltage to a wordline indicated by an address ADDR among the wordlines WL according to the control of the control logic circuit 219.

The page buffer circuit 215 is connected to the memory cell array 211 through a plurality of bitlines BL. The page buffer circuit 215 is connected to the data I/O circuit 217 through a plurality of data lines DL. The page buffer circuit 215 operates according to the control of the control logic circuit 219.

The page buffer circuit 215 may store data to be programmed to memory cells of the memory cell array 211 or data read from the memory cells. During a program operation, the page buffer circuit 215 may store data to be programmed into memory cells. The page buffer circuit 215 may bias a plurality of bitlines BL, based on the stored data. During the program operation, the page buffer circuit 215 may function as a write driver. During a read operation, the page buffer circuit 215 may sense voltages of bitlines BL and store a result of the sensing. During the read operation, the page buffer circuit 215 may function as a sense amplifier.

The data I/O circuit 217 is connected to the page buffer circuit 215 through a plurality of data lines DL. The data I/O circuit 217 may exchange data DATA with the memory controller 220 (see FIG. 3).

The data I/O circuit 217 may temporarily store the data DATA received from the memory controller 220. The data I/O circuit 217 may transmit the stored data to the page buffer circuit 215. The data I/O circuit 217 may temporarily store the data DATA transmitted from the page buffer circuit 215. The data I/O circuit 217 may transmit the stored data DATA to the memory controller 220. The data I/O circuit 217 may function as a buffer memory.

The control logic circuit 219 receives a command CMD from the memory controller 220. The control logic circuit 219 may decode the received command CMD and control the overall operation of the nonvolatile memory 210 according to the decoded command CMD. The control logic circuit 219 may further receive various control signals and voltages from the memory controller 220 (see FIG. 14).

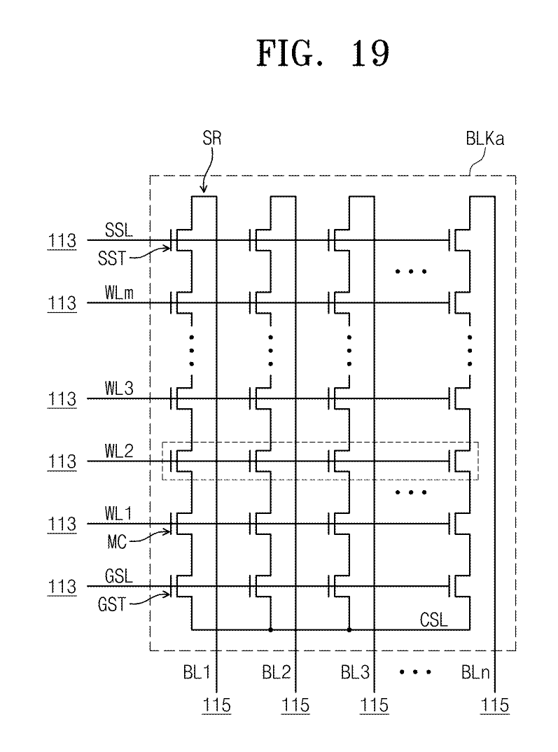

FIG. 19 is a circuit diagram of a memory block BLKa according to an embodiment of the inventive concept. Among a plurality of memory blocks BLK1 to BLKz of the memory cell array 211 shown in FIG. 18, one memory block BLKa is exemplarily shown in FIG. 19.

Referring to FIGS. 18 and 19, the memory block BLKa includes a plurality of strings SR. The strings SR may be connected to a plurality of bitlines BL1 to BLn, respectively. Each of the strings SR includes a ground selection transistor GST, memory cells MC, and a string selection transistor SST.

A ground selection transistor GST of each string SR is coupled between memory cells MC and a common source line CSL. The ground selection transistors GST of the strings SR are commonly connected to the common source line CSL.

A string selection transistor SST of each string SR is coupled between memory cells MC and a bitline BL. String selection transistors SST of the strings SR are connected to the bitlines BL1 to BLn, respectively. The bitlines BL1 to BLn may be connected to the page buffer circuit 115.

In each string SR, a plurality of memory cells MC are provided between a ground selection transistor GST and a string selection transistor SST. In each string SR, a plurality of memory cells MC are connected in series.

In the strings SR, memory cells MC disposed at the same position from the common source line CSL may be commonly connected to a single wordline. Memory cells of the strings SR may be connected to a plurality of wordlines WL1 to WLm. The wordlines WL1 to WLm may be connected to the address decoder circuit 213.

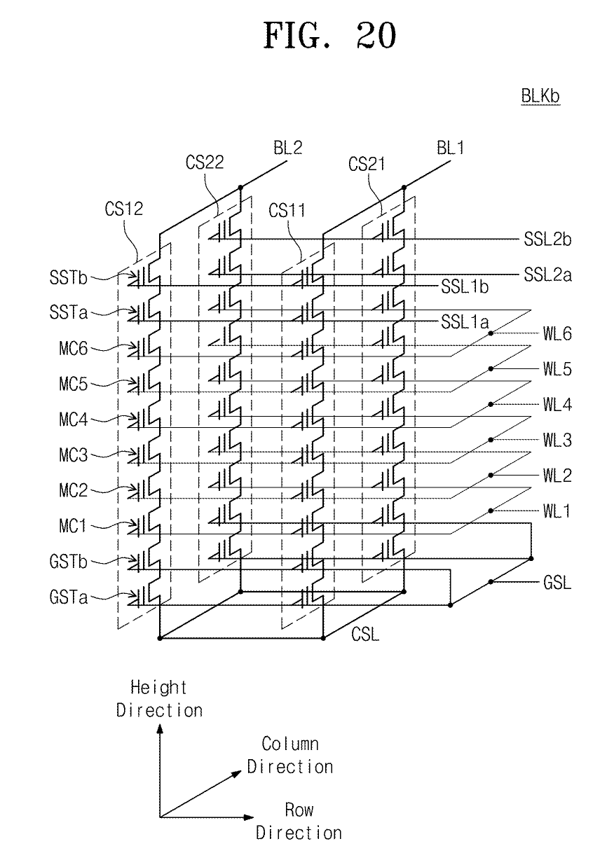

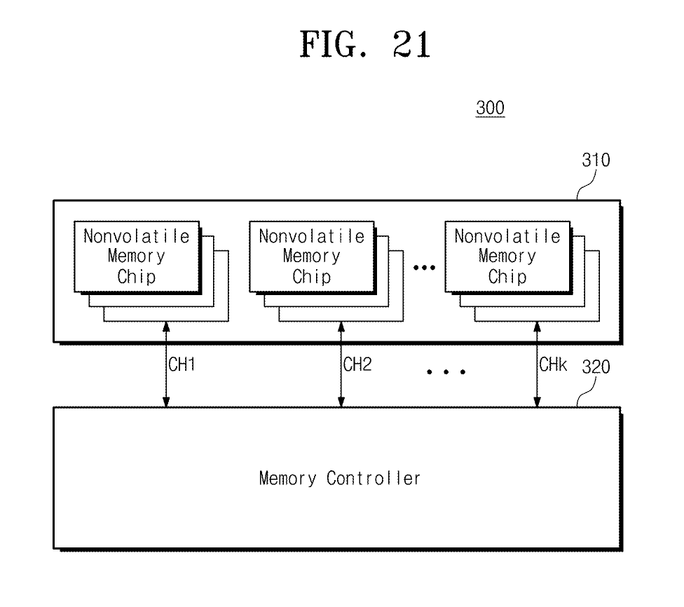

FIG. 20 is a circuit diagram of a memory block BLKb according to another embodiment of the inventive concept. As illustrated, the memory block BLKb includes a plurality of cell strings CS11 to CS21 and CS12 to CS22. The cell strings CS11 to CS21 and CS12 to CS22 may be arranged in a row direction and a column direction to form rows and columns.

For example, the cell strings CS11 and CS12 arranged in the row direction may form a first row, and the cell strings CS21 and CS22 arranged in the row direction may form a second row. The cell strings CS11 and CS21 arranged in the column direction may form a first column, and the cell strings CS12 and CS22 arranged in the column direction may form a second column.

Each cell string may include a plurality of cell transistors. The cell transistors include ground selection transistors GSTa and GSTb, memory cells MC1 to MC6, and string selection transistors SSTa and SSTb. The ground selection transistors GSTa and GSTb, the memory cells MC1 to MC6, and the string selection transistors SSTa and GSTb of each cell string may be stacked in a direction perpendicular to a plane on which the cell strings CS11 to CS21 and CS12 to CS22 are arranged in a matrix of rows and columns (e.g., a plane on a substrate of the memory block BLKb).

Lowermost ground selection transistors GSTa may be commonly connected to the common source line CSL.

The ground selection transistors GSTa and GSTb of the cell strings CS11 to CS21 and CS12 to CS22 may be commonly connected to the ground selection line GSL.

In some embodiments, ground selection transistors of the same height (or order) may be connected to the same ground selection line, and ground selection transistors of different heights (or orders) may be connected to different ground selection lines. For example, ground selection transistors GSTa of first height may be commonly connected to a first ground selection line, and ground selection transistors of second height may be commonly connected to a second ground selection line.

In some embodiments, ground selection transistors of the same row may be connected to the same ground selection line, and ground selection transistors of different rows may be connected to different ground selection lines. For example, ground selection transistors GSTa and GSTb of cell strings CS11 and CS12 of a first row may be connected to a first ground selection line, and ground selection lines GSTa and GSTb of cell strings CS21 and CS22 of a second row may be connected to a second ground selection line.

Memory cells disposed at the same height (or order) from a substrate (or ground selection transistors GST) may be connected to a single wordline, and memory cells disposed at different heights (or orders) may be connected to different wordlines WL1 to WL6, respectively. For example, memory cells MC1 are commonly connected to the wordline WL1. Memory cells MC3 are commonly connected to the wordline WL4. Memory cells MC4 are commonly connected to the wordline WL5. Memory cells MC6 are commonly connected to the wordline WL6.

In a first string selection transistor SSTa of the same height (or order) of the cell strings CS11 to CS21 and CS12 to CS22, first string selection transistors SSTa of different rows are connected to different string selection lines SSL1a to SSL2a, respectively. For example, first string selection transistors SSTa of the cell strings CS11 and CS12 are commonly connected to a string selection line SSL1a. First string selection transistors SSTa of the cell strings CS21 and CS22 are commonly connected to a string selection line SSL2a.

In a second string selection transistor SSTb of the same height (or order) of the cell strings CS11 to CS21 and CS12 to CS22, second string selection transistors SSTb of different rows are connected to different string selection lines SSL1b to SSL2b, respectively. For example, second string selection transistors SSTb of the cell strings CS11 and CS12 are commonly connected to a string selection line SSL1b. First string selection transistors SSTb of the cell strings CS21 and CS22 are commonly connected to a string selection line SSL2b.

That is, cell strings of different rows are connected to different string selection lines. String selection transistors of the same height (or order) of the same row are connected to the same string selection line. String selection transistors of different heights (or orders) of the same row are connected to different string selection lines.

In some embodiments, string selection transistors of cell strings of the same row may be connected to a single string selection line. For example, string selection transistors SSTa and SSTb of a first row may be commonly connected to a single string selection line. String selection transistors SSTa and SSTb of cell strings CS21 and CS22 of a second row may be commonly connected to a single string selection line.

Columns of a plurality of cell strings CS11 to CS21 and CS12 to CS22 are connected to different bitlines BL1 and BL2, respectively. For example, string selection transistors SSTb of cell strings CS11 to CS21 of a first column are commonly connected to a bitline BL1. String selection transistors SST of cell strings CS12 to CS22 of a second column are commonly connected to a bitline BL2.

The memory block BLKb shown in FIG. 20 is merely exemplary. The inventive concept is not limited the memory block BLKb shown in FIG. 20. For example, the number of rows of cell strings may increase or decrease. As the number of rows of cell strings varies, the number of string selection lines or ground selection lines connected to rows of the cell strings and the number of cell strings connected to a single bitline may also vary.

The number of columns of cell strings may increase or decrease. As the number of columns of cell strings varies, the number of bitlines connected to the columns of the cell strings and the number of cell strings connected to a single string selection line may also vary.

The height of cell strings may increase or decrease. For example, the number of ground selection transistors, memory cells or string selection transistors stacked on the respective cell strings may increase or decrease.

In some embodiments, write and read operations may be performed in units of rows of the cell strings CS11 to CS21 and CS12 to CS22. The cell strings CS11 to CS21 and CS12 to CS22 may be selected in unit of a single row by the string selection lines SSL1a, SSL1b, SSL2a, and SSL2b.

On a selected row of cell strings CS11 to CS21 and CS12 to CS22, write and read operations may be performed in units of wordlines. On the selected row of cell strings CS11 to CS21 and CS12 to CS22, memory cells connected to a selected wordline may be programmed.

In an embodiment of the present inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer. Each vertical NAND string further includes at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

FIG. 21 is a block diagram of a storage device 300 according to another embodiment of the inventive concept. As illustrated, the storage device 300 includes a nonvolatile memory 310 and a memory controller 320. The nonvolatile memory 310 includes a plurality of nonvolatile memory chips. The nonvolatile memory chips are divided into a plurality of groups. Each of the groups of the nonvolatile memory chips is configured to communicate with the memory controller 320 through a single common channel. In FIG. 21, it is exemplarily shown that the nonvolatile memory chips communicate with the memory controller 320 through first to kth channel CH1 to CHk.

In FIG. 21, it has been described that a plurality of nonvolatile memory chips are connected to a single channel. However, the memory system 200 may be changed such that a single nonvolatile memory chip is connected to a single channel.

The memory controller 320 may independently perform a read operation on the respective channels CH1 to CHk. When at least two read requests correspond to different channels respectively, a computing device 100 (see FIG. 1) may determine corresponding read requests to be a merge target. According to this embodiment, at least two internal read requests split from a merged internal read request correspond to different channels. Therefore, the at least two internal read request may be executed concurrently. That is, the time taken for the computing device 100 to transmit a read request to the storage device 300 is reduced and time taken to execute the transmitted read request is also reduced.

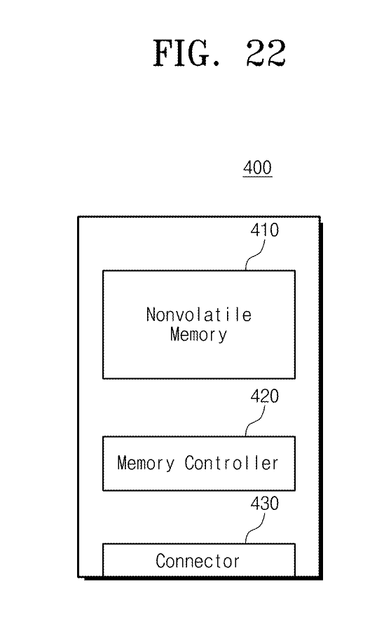

FIG. 22 is a block diagram of a storage module 400 according to an embodiment of the inventive concept. As illustrated, the storage module 400 includes a nonvolatile memory 410, a memory controller 420, and a connector 430.

The memory controller 420 may support a split function according to an embodiment of the inventive concept.

The connector 430 may connect the storage module 400 to an external device. The connector 430 may include a socket based on standards such as SATA (Serial AT Attachment), eSATA, PCI (Peripheral Component Interconnect), PCI-e, NVMe, SCSI (Small Computer System Interface), SAS (Serial Attached SCSI), USB (Universal Serial Bus), Mini USB, Micro USB, and Firewire. The connector 430 may include connecting means such as a pin grid array (PGA) and a ball grid array (BGA).

The storage module 400 may constitute various storage modules such as a solid-state drive (SSD), a person computer memory card international association (PCMCIA) card, a compact flash card (CF), smart media cards (SM and SMC), a memory stick, multimedia cards (MMC, RS-MMC, and MMCmicro), SD cards (SD, miniSD, microSD, and SDHC), a universal flash storage (UFS) module, and an embedded MMC (eMMC) module.

As described above, according to embodiments of the inventive concept, at least two read requests meeting conditions may merge into a single internal read request. Thus, time taken for the computing device 100 to transmit a read request to the storage device 200 is reduced.

In the foregoing embodiments, the inventive concepts have been described with reference to a read request. However, the inventive concepts are not limited to the read request. That is, a merge mode according to the inventive concept may be supported with respect to not only a read request but also special requests such as a write request, an erase request, and state check.

As described in the foregoing embodiments of the inventive concept, two or more requests can be transmitted after merging into a single request. Thus, time taken for a computing device to transmit a request to a storage device can be reduced.

While the inventive concepts have been particularly shown and described with reference to exemplary embodiments thereof, it will be understood by those of ordinary skill in the art that various changes in form and details may be made therein without departing from the spirit and scope of the inventive concepts as defined by the following claims. For example, it is possible to adjust the driving capability of a sub word line driver or adjust the slope of level of applied driving signals by changing, adding, or removing the circuit configuration or arrangement in the drawings without departing from the technical spirit of the inventive concepts in other cases.

What is claimed is:

1. A method for operating a nonvolatile memory device including a nonvolatile memory and a memory controller configured to control the nonvolatile memory, the method comprising:
receiving a read request;
determining whether the received read request is a merged request;
splitting the received read request into at least two read requests and executing the at least two read requests if the received read request is the merged request; and
executing the received read request if the received read request is not the merged request.

2. The method as set forth in claim 1, wherein the read request includes a frame information structure (FIS) based on a serial ATA (SATA) standard.

3. The method as set forth in claim 1, wherein the determining is performed by checking flag information included in the read request.

4. The method as set forth in claim 1, wherein the determining is performed by checking a value of a last one of address bits included in the read request.

5. The method as set forth in claim 1, wherein a determination operation is performed to determine whether a value of an address included in the received read request is within a range of an address of the nonvolatile memory if the received read request is not the merged request, and
wherein the determination operation is omitted if the received read request is the merged request.

6. The method as set forth in claim 1, wherein at least two addresses respectively corresponding to the at least two read requests are extracted from an address field of the received read request if the received read request is the merged request.

7. The method as set forth in claim 1, wherein at least two cluster counts respectively corresponding to the at least two read requests are extracted from a feature field of the received read request if the received request is the merged request.

8. The method as set forth in claim 1, wherein at least two cluster counts respectively corresponding to the at least two read requests are extracted from a count field of the received read request if the received read request is the merged request.

9. The method as set forth in claim 1, wherein an address included in the received read request indicates one of clusters assigned to the nonvolatile memory, and
wherein each of the clusters includes at least two sectors.

10. A method for operating a computing device configured to access a nonvolatile storage device, the method comprising:
generating at least two read requests for the nonvolatile storage device;
determining whether the at least two read requests correspond to a merge target;
merging the at least two read requests into a single read request and transmitting the merged read request to the nonvolatile storage device if the at least two read requests correspond to the merge target; and
transmitting the at least two read requests to the nonvolatile storage device respectively if the at least two read requests do not correspond to the merge target.

11. The method as set forth in claim 10, wherein the determining is performed according to a total size of data requested by the at least two read requests.

12. The method as set forth in claim 10, wherein the determining comprises:
determining that the at least two read requests correspond to the merge target if a total size of data requested by the at least two read requests is equal to or smaller than a maximum transmission unit indicating a maximum size of data that the computing device communicates with the nonvolatile storage device at one time; and
determining that the at least two read requests do not correspond to the merge target if the total size of data requested by the at least two read requests is greater than the maximum transmission unit.

13. The method as set forth in claim 10, wherein the single read request includes a frame information structure (FIS) based on a serial ATA (SATA) standard.

14. The method as set forth in claim 10, wherein the computing device supports a native command queuing (NCQ).

15. The method as set forth in claim 10, wherein an address included in the single read request indicates a single cluster assigned to the nonvolatile memory device, and
wherein each cluster assigned to the nonvolatile memory device includes two or more clusters.

16. A storage device comprising:
a nonvolatile memory; and
a memory controller configured to control the nonvolatile memory,
wherein the memory controller includes:
a memory interface configured to read data from the nonvolatile memory; and
a host interface configured to receive a read request from an external device,
wherein when the received read request is a merged read request, the host interface is configured to split the received read request into at least two read requests and transfer the split at least two read requests to the memory interface, and
wherein when the received read request is not the merged read request, the host interface is configured to transfer the received read request to the memory interface.

17. The storage device of claim 16, wherein the host interface is configured to output data to the external device at least twice according to the received read request when the read request is the merged read request.

18. The storage device of claim 16, wherein the host interface is configured to check an address of the received read request to determine whether the address is valid or not when the received read request is not the merged read request,
wherein the host interface is configured not to check the address to determine whether the address is valid when the received read request is the merged read request.

19. The storage device of claim 16, wherein the host interface is configured to determine whether the received read request is the merged request or not according to a first flag bit of the received read request and determine whether the received read request supports a merge mode, which allows the merged read request, according to a second flag bit of the received read request.

20. The storage device of claim 16, wherein the nonvolatile memory device includes:
a plurality of cell strings arranged in rows and columns on a substrate, each cell sting including at least one ground select transistor, a plurality of memory cells and at least one string select transistor, which are sequentially stacked on the substrate in a direction perpendicular to the substrate.
